(19) United States
(12) Patent Application Publication
(10) Pub. No.: US 2015/0193579 A1
(43) Pub. Date: Jul. 9, 2015

(54) Exchanging Medical Imaging Data Between Computer Systems

(71) Applicants: Richard James Bruce, Verona, WI (US); George John Wendt, Middleton, WI (US)

(72) Inventors: Richard James Bruce, Verona, WI (US); George John Wendt, Middleton, WI (US)

(73) Assignee: WITS(MD), LLC., Middleton, WI (US)

(21) Appl. No.: 14/151,286

(22) Filed: Jan. 9, 2014

(51) Int. Cl. G06F 19/00; H04L 29/08

(52) U.S. Cl. CPC G06F 19/321; H04L 67/10

(57) ABSTRACT

In one example of exchanging medical imaging data between computer systems, input to execute a computer software application to exchange data with a server in a computer session is received while the computer executes another computer software application to exchange data with another server. In response to receiving the input, the computer software application is executed to provide multiple functionalities, one of which is a functionality to provide additional data to the server system using a mobile computer. In response to detecting the selection of the functionality to provide additional data to the server using the mobile computer, an identifier that identifies the computer session in which the data is being exchanged between the computer and the server is displayed at the computer. Data can be received using the mobile computer by scanning the identifier.

### TECHNICAL FIELD

This disclosure relates to computer-implemented methods, computer-readable storage media, and computer systems for managing medical imaging data.

### BACKGROUND

Patients in many health care facilities are highly mobile. This, particularly, applies to patients seen at tertiary care centers. Often, a majority of patients seen at tertiary care centers receive their primary care elsewhere. This often includes prior diagnostic imaging. Review of available prior diagnostic imaging is, frequently, a focal step in the care or treatment decision-making process. For many diagnoses, care cannot proceed until diagnostic imaging is available for the provider to review. For these reasons, the timely availability and accessibility of outside diagnostic medical imaging can be important to providing efficient care and patient satisfaction. In addition, due to the proliferation of mobile computing devices, visible light medical imaging (e.g. medical photographs or videos of patients) are frequently acquired by providers at the point-of-care. Ensuring that medical imaging transported or acquired on mobile devices is associated with the correct patient and efficiently and universally archived within the medical record has become a growing challenge for many health care organizations. Medical data including medical imaging left on mobile devices and not transferred to the appropriate medical record repositories can also represent significant privacy risks as well as contribute to incomplete medical documentation and problematic patient care workflows.

### SUMMARY

This disclosure relates to computer-implemented methods, computer-readable storage media, and computer systems for exchanging medical data, including medical imaging data, between computer systems.

In general, one innovative aspect of the subject matter described here can be implemented as a computer-implemented method. Input to execute a first computer software application to exchange data with a first server computer system in a computer session is received. The first computer system executes a second computer software application exchange data. In response to receiving the input, the first computer software application is launched at the first computer system. Instructions to provide multiple functionalities are received at the first computer system and from the first server computer system. Each functionality is executable to provide additional data to the server computer system. The multiple functionalities, including a functionality to provide the additional data using a second computer system, are provided at the first computer system. A selection of the functionality to provide the additional data using the second computer system is detected. In response to detecting the selection, an identifier that identifies the computer session in which the data is being exchanged between the first computer system and the first server computer system is received at the first computer system and from the first server computer system. The identifier is displayed at the first computer system.

This, and other aspects, can include one or more of the following features. The data can include medical imaging data or patient-related information describing a patient (or both). The medical imaging data can include data objects encoded in Digital Imaging and Communication in Medicine (DICOM) format. Multiple selectable objects can be displayed in a display device connected to the first computer system. Each selectable object represents a functionality of the multiple functionalities. A selection of a selectable object of the multiple objects that corresponds to the functionality to provide the additional data using the second computer system can be detected. The additional data can include additional patient-related information including medical imaging data in a non-DICOM format, e.g., at least one of a JPEG, GIF, PNG, MPG, MP4, or MOV format. A user interface associated with the second computer software application can be displayed at the first computer system. A selectable user interface element associated with the first computer software application can be displayed in the user interface. A selection of the selectable user interface element can be detected. In response to detecting a selection of the selectable user interface element, the patient-related information can be caused to be sent from the second computer software application to the first computer software application from the first computer system. The identifier that identifies the computer session in which the data is being exchanged between the first computer system and the server computer system can include a quick response (QR) code that includes a computer session identifier. The identifier displayed at the first computer system can be received at the second computer system. The additional data can be received at the second computer system. The received additional data and the identifier that identifies the computer session in which the data is being exchanged between the first computer system and the first server computer system can be transmitted to the by the second computer system to the first server computer system. The first server computer system can receive the additional data from the second computer system and the identifier. The first server computer system can associate the additional data with the data that is being exchanged in the computer session identified by the identifier.

Another innovative aspect of the subject matter described here can be implemented as a system including one or more processors and a computer-readable medium storing instructions executable by the one or more processors to perform operations. The operations include receiving, from a first computer system and in a computer session, data and an identifier identifying a user of the first computer system. In response to receiving the data and the identifier identifying the user, a computer session identifier identifying the computer session in which the data is received from the first computer system is generated. The data is exchanged with the first computer system in the computer session. A second request to access computer sessions associated with the identifier that identifies the user of the first computer system is received from a second computer system. In response to receiving the second request, access to the computer session in which the data is received from the first computer system is provided to the second computer system. Additional data is received from the second computer system in the computer session to which the second computer system has received access.

This, and other aspects, can include one or more of the following features. The data can include medical imaging data or patient-related information describing a patient (or both). The medical imaging data can include data objects encoded in Digital Imaging and Communication in Medicine (DICOM) format. To receive the second request to access the computer sessions associated with the identifier from the second computer system, an encoded version of the identifier that identifies the user of the first computer system can be received from the second computer system. Exchanging patient-related information in the computer session with the first computer system can include receiving, from the first computer system, medical imaging data associated with the patient, the medical imaging data including data objects encoded in Digital Imaging and Communication in Medicine (DICOM) format. The additional data can include additional patient-related information including medical imaging data in a non-DICOM format, e.g., at least one of a JPEG, GIF, PNG, MPG, MP4, or MOV format. Multiple computer session identifiers can be provided to the second computer system. Each computer session identifier can identify a respective computer session associated with the identifier identifying the user of the first computer system. The multiple computer session identifiers can include the generated computer session identifier. A selection of the generated computer session identifier can be received from the first computer system. A third request to access computer sessions associated with the identifier that identifies the user of the first computer system can be received from a third computer system. In response to receiving the third request, access to the computer session in which the patient-related information is received from the first computer system can be provided to the third computer system. Additional data, e.g., patient-related information, can be received from the third computer system and in the computer session to which the third computer system has received access.

A further innovative aspect of the subject matter described here can be implemented as a non-transitory computer-readable medium storing instructions executable by one or more processors to perform operations. An identifier that identifies a computer session in which data is being exchanged between the client computer system and a server computer system is received from a client computer system. Additional data is received. The identifier that identifies the computer session is associated with the additional data. The additional data with the associated identifier is provided to the server computer system.

This, and other aspects, can include one or more of the following features. The data can include medical imaging data or patient-related information describing a patient (or both). The medical imaging data can include data objects encoded in Digital Imaging and Communication in Medicine (DICOM) format. The additional data can include additional patient-related information describing the patient in a DICOM format or in a non-DICOM format, e.g., at least one of a JPEG, GIF, PNG, MPG, MP4, or MOV format, or both. The identifier can include a quick response (QR) code. Receiving the identifier can include receiving a scanned image of the QR code. The additional data can be received by executing an image capture application. Input to execute a computer software application to exchange the patient-related information describing the patient with a server computer system can be received. In response to receiving the input, a functionality of the computer software application to receive the identifier that identifies the computer session can be executed.

While generally described as computer-implemented software embodied on computer-readable media (e.g., non-transitory, tangible, or other media) that processes and transforms the respective data, some or all of the aspects may be computer-implemented methods or further included in the respective systems or other devices for performing the functionalities described here. The details of these and other aspects, and implementations of the present disclosure are set forth in the accompanying drawings and the description below. Other features and advantages of the disclosure will be apparent from the description and drawings, and from the claims.

### BRIEF DESCRIPTION OF THE DRAWINGS

FIG. 1 illustrates a schematic drawing of example computer systems for exchanging medical imaging data.

FIG. 2 is a flowchart of an example process for providing a computer session for exchanging medical imaging data to a computer system.

FIG. 3 describes an example workflow implemented by multiple computer systems to exchange medical imaging data.

FIG. 4 is a flowchart of an example process for providing medical imaging data to a computer system.

FIG. 5 is a flowchart of an example process for receiving medical imaging data from multiple computer systems in the same computer session.

FIG. 6 describes an example workflow implemented by multiple computer systems to exchange medical imaging data.

FIG. 7 describes an example workflow implemented by multiple computer systems to exchange medical imaging data.

FIG. 8 illustrates an example of a user interface including functionalities to provide medical imaging data.

FIG. 9 illustrates an example of a user interface including an identifier of a computer session to exchange medical imaging data.

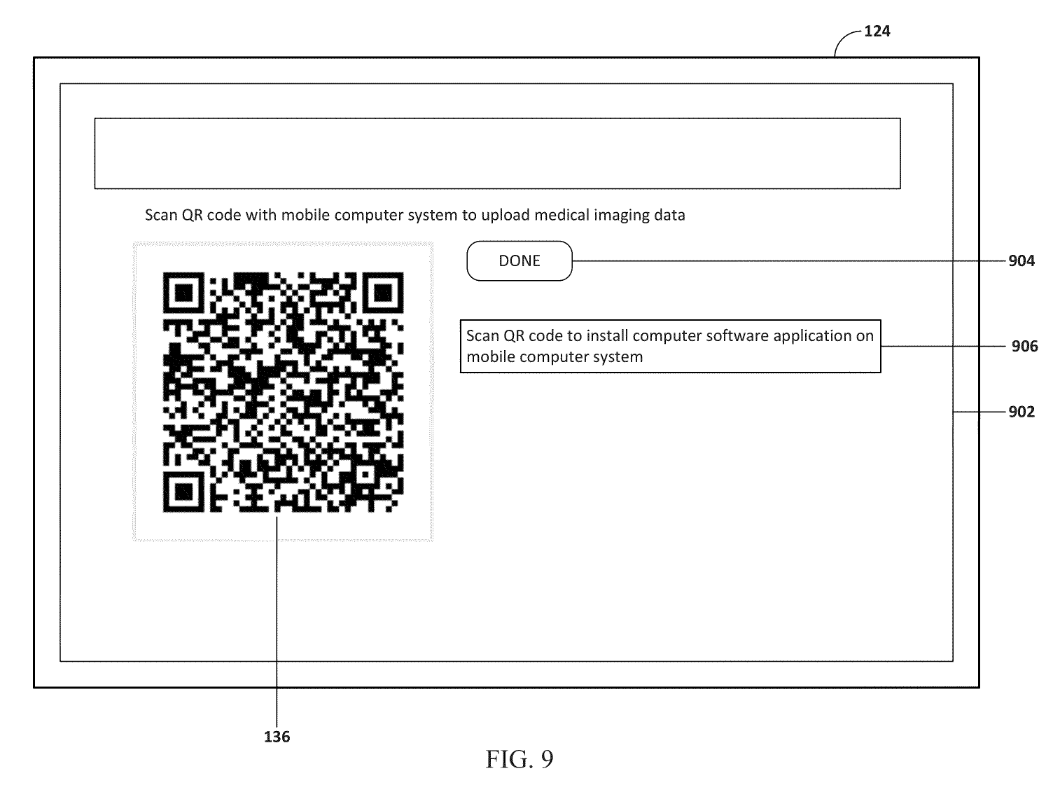

Like reference numbers and designations in the various drawings indicate like elements.

### DETAILED DESCRIPTION

This disclosure relates to computer-implemented methods, computer-readable storage media, and computer systems for exchanging medical data, including medical imaging data, between computer systems. One method for transport of prior medical data is on physical media (CD, DVD, flash memory such as thumb drive or flash memory card, or other physical media). Outpatients who have been transferred from outside for tertiary care will frequently bring physical media with, for example, prior imaging to their initial office appointment. Sometimes, outside imaging can be requested and received, e.g., after the initial office visit. Medical imaging can include visible light images such as those captured using devices that implement cameras. Many providers prefer to have outside patient medical imaging loaded onto server computer systems, e.g., enterprise medical imaging archive and review systems, picture archiving and communication systems (PACS), or other server computer systems. This allows outside imaging to be viewed across the healthcare enterprise with a system with which the providers are familiar. Loading outside medical imaging data onto the PACS can also allow the medical imaging data to be compared directly to any other medical imaging data within the archive.

For example, medical imaging data can be exchanged between one or more client computer systems and one or more server computer systems utilizing one or more computer sessions. In some situations, the patient can provide physical media including medical imaging data to a provider. Using a first client computer system, the provider can upload the medical imaging data to the server computer system. The patient may additionally request the provider to evaluate the patient. To do so, the provider may obtain additional medical imaging data at a second client computer system that is separate from the first client computer system. By implementing the techniques described here, the first and second client computer systems can securely provide the medical imaging data stored on the physical media and the additional medical imaging data to the server computer system. In particular, the first client computer system can provide the second client computer system information that is sufficient to identify a computer session in which the medical imaging data is being exchanged with the server computer system without exchanging private information associated with the patient or patient encounter. In addition, the first client computer system can provide one or more user interfaces which the second client computer system can easily identify the computer session in which the first client computer system is exchanging medical imaging data with the server computer system. Identifying the computer session allows the second client computer system to provide medical imaging data for association with the patient without receiving the patient's private information. Capture of medical imaging data, including visible light images, from providers' mobile devices in a workflow that is seamless and that can be standardized can be facilitated. Patient privacy can be protected by negating a need for providers to store the medical imaging data on the mobile devices. Because a computer session in which the medical imaging data is being exchanged is known, a quantity of data entry on the providers' devices to identify the data can be decreased (e.g., minimized or eliminated).

Implementations of the techniques described in this disclosure can allow health care providers to quickly associate a mobile or secondary device to a data exchange session associated with that patient and upload medical imaging or patient data. No patient data need be passed to the mobile device reducing potential privacy concerns, and no data need be manually input by the provider to associate the data being transfer with the patient. This functionality allows workflows to be implemented to acquire or import outside diagnostic medical imaging which can include, e.g., visible light images, to central repositories which, in turn, can provide the diagnostic medical imaging across several platforms

Example implementations of the techniques described here are described below with reference to medical imaging data. The techniques can, alternatively or additionally, be implemented with reference to any type of data that can be exchanged between computer systems. The non-imaging data can include, e.g., documents including text describing medical images, or other non-images, PDF files, non-images in HL7, CDA, XML formats, or other non-images in other formats.

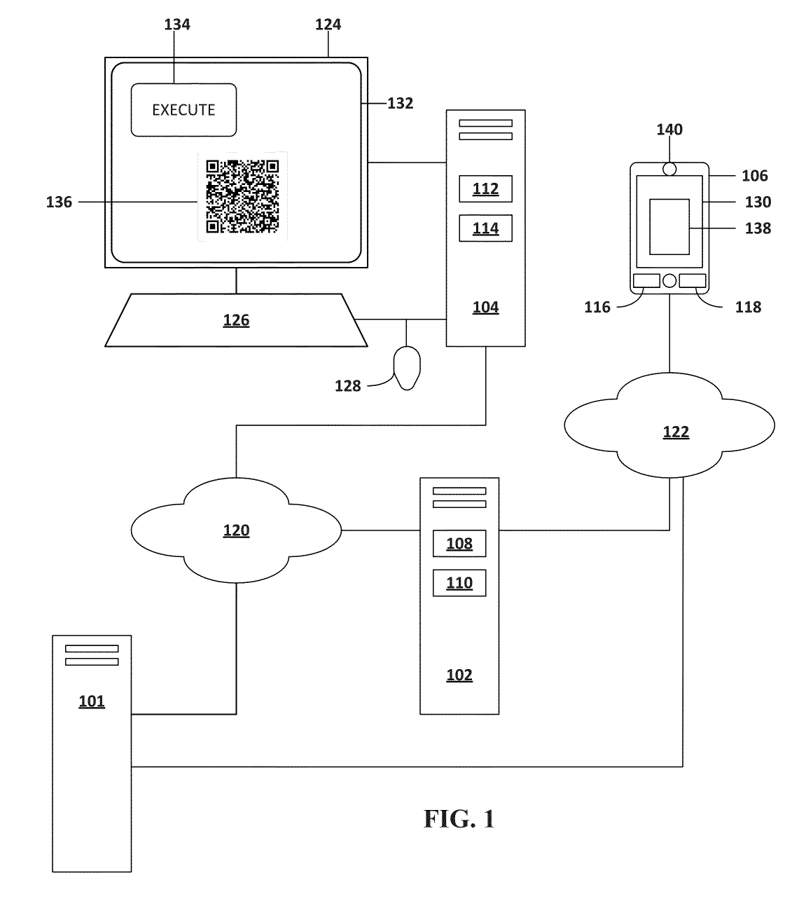

FIG. 1 illustrates a schematic drawing of example computer systems for exchanging medical imaging data. In some implementations, the computer systems can include a first server computer system 101, a second server computer system 102, a first client computer system 104, and a second client computer system 106 connected to each other through one or more wired or wireless networks 120 and 122. The first server computer system 101 can be a host system, e.g., PACS, Electronic Medical Record (EMR), or other host system, that receives patient-related information including medical imaging data received from multiple sources including, e.g., physical media, medical imaging modalities (i.e., any device which acquires or generates medical imaging such as CT scanner, MRI scanner, x-ray image processor, ultrasound machine, image processing workstation, or other modalities), or other sources. The second server computer system 102 can be implemented as an intermediary computer system that can receive medical imaging data from one or more or all of the multiple sources, and transmit (e.g., by processing and routing) the medical imaging data to the first server computer system 101. In some implementations, the second server computer system 102 can be implemented to store the received medical imaging data, e.g., temporarily or permanently.

Client computer systems, such as the first client computer system 104, the second client computer system 106, or other client computer systems (not shown), can exchange medical imaging data or other data, e.g., by providing the data to or receive the data from (or both), with the first server computer system 101 or the second server computer system 102 or both. The data can include medical imaging data conforming to, e.g., data objects encoded in, the Digital Imaging and Communications in Medicine (DICOM) format or medical imaging data in non-DICOM format or combinations of them. The medical imaging data can include images in any image format (e.g., JPEG, GIF, PNG, or other image format) or non-images associated with medical imaging (e.g., documents including text describing medical images, or other non-images). For example, the non-images can include PDF files, video files, non-images in HL7, CDA, XML formats, or other non-images in other formats.

The second server computer system 102 can include a computer-readable medium 108 storing computer instructions executable by data processing apparatus (e.g., one or more processors 110) to execute the computer instructions to perform operations including managing patient-related information that includes medical imaging data, and communicating with one or more client computer systems to exchange all or portions of the patient-related information. The second server computer system 102 can transfer the patient-related information to other computer systems such as the first server computer system 101 that hosts the information, PACS, computer systems that maintain Electronic Medical Records (EMRs), or other computer systems. In addition to the medical imaging data, the patient-related information can include information describing a patient or patient encounter (or both) with which the medical imaging data is associated. Such information can include the patient's personal information (e.g., name, contact information), the patient's care provider, patient diagnoses received from the provider, scheduled appointment information, and other information describing the patient or encounter or both.

In some implementations, the second server computer system 102 can grant access to the patient-related information to one or computer systems that have previously been authenticated to receive such information. For example, the second server computer system 102 can perform operations that can provide access to the patient-related information as EMRs. The second server computer system 102 can be implemented as a single computer system or as a distributed server computer system or combinations of them.

In some implementations, the first client computer system 104 is connected to the first server computer system 101 or the second server computer system 102 (or both) over the wired or wireless networks 120, e.g., the Internet. The first client computer system 104 can include a computer-readable medium 112 storing computer instructions executable by data processing apparatus (e.g., one or more processors 114) to execute the computer instructions to perform operations including receiving the patient-related information including the patient encounter information, e.g., as EMRs, from the first server computer system 101. In some implementations, the first client computer system 104 can locally execute a computer software application to communicate with the first server computer system 101 to receive the patient-related information from the first server computer system 101. Alternatively, the first client computer system 104 can establish remote computer sessions with the first server computer system 101 to receive the patient-related information, e.g., via Virtual Private Networks (VPNs), server/desktop virtualization software, or the like. In addition, the first client computer system 104 can execute a computer software application to communicate with the second server computer system 102 to exchange medical imaging data with the second server computer system 102. In some implementations, the first client computer system 104 is a stationary computer system, e.g., desktop computer system or other computer system that generally remains at the same location. Alternatively, the first client computer system can be a mobile computer system, e.g., a smartphone, laptop computer system, a tablet computer system, personal digital assistant, or other mobile computer system.

In some implementations, the second client computer system 106 is connected to the first server computer system 101 or the second server computer system 102 over the wired or wireless networks 122, e.g., the Internet. The second client computer system 106 can include a computer-readable medium 116 storing computer instructions executable by data processing apparatus (e.g., one or more processors 118) to execute the computer instructions. For example, the second client computer system 106 can execute a computer software application to perform operations including receiving medical imaging data, e.g., in non-DICOM format (such as visible light images, video, and the like), for transmitting to the second server computer system 102. The second client computer system 106 can also implement operations to identify a computer session in which the second server computer system 102 is exchanging patient-related information with another computer system such as the first client computer system 104, and other operations. In some implementations, the second client computer system 106 can be a mobile computer system, e.g., a smartphone, laptop computer system, a tablet computer system, personal digital assistant, or other mobile computer system. The second client computer system 106 can include a camera that can capture medical imaging data in the non-DICOM format, e.g., images of skin lesions on a patient. Alternatively, or in addition, the second client computer system 106 can execute a computer software application to receive medical imaging data in the non-DICOM format from devices, e.g., a camera, a smartphone, a tablet computer, or other devices. Examples of operations performed by the computer systems shown in FIG. 1 are described below.

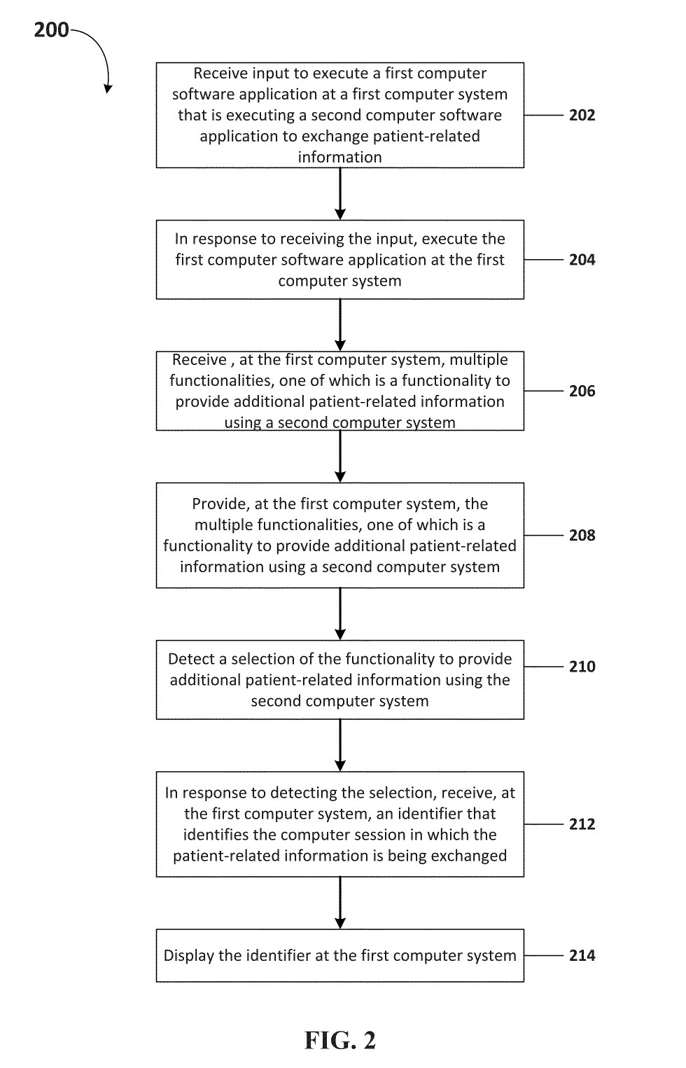

FIG. 2 is a flowchart of an example process 200 for providing a computer session for exchanging medical imaging data to a computer system. In some implementations, the first client computer system 104 can implement the process 200 in conjunction with the first server computer system 101, the second server computer system 102 and the second client computer system 106. At 202, input to execute a first computer software application to exchange medical imaging data with the second server computer system 102 is received. For example, the first client computer system 104 can be communicating with the first server computer system executing a second computer software application (e.g., EMR client software application) to exchange patient-related information with the first server computer system 101. A user of the first client computer system 104 provides the input to launch the first computer software application during execution of this second computer software application. For example, the first server computer system 101 can execute the second computer software application to cause the first client computer system 104 to display a selectable icon (e.g., “Execute” button 134) in a user interface while the first client computer system 104 is executing the second computer software application. The user can select the selectable object to execute the first computer software application. Context-specific patient and patient encounter related data can be encoded by the second computer application and passed to the first computer application as part of the launch process. For example, the first computer application can be launched by calling a URL with patient-related data encoded into a URL query string.

At 204, the first computer software application is executed in response to receiving the input. For example, the first client computer system 104 can execute the first computer software application in response to the user selecting the selectable icon. In some implementations, the first computer software application can, e.g., take the form of a plug-in incorporated into the second computer software application, a local application, or a web application accessed via a browser. As described below, the first client computer system 104 can execute the first computer software application to exchange medical imaging data from one or more of multiple sources.

At 206, multiple functionalities can be received, each of which is executable to provide additional patient-related information describing the patient. For example, the first client computer system 104 can receive multiple functionalities from the second server computer system 102. For example, the first client computer system 104 can receive, from the second server computer system 102, computer instructions executable by the first client computer system 104 to display a user interface including the multiple functionalities to provide medical imaging data in the display device 124. The multiple functionalities can include a functionality to provide additional patient-related information using a computer system other than the first client computer system 104.

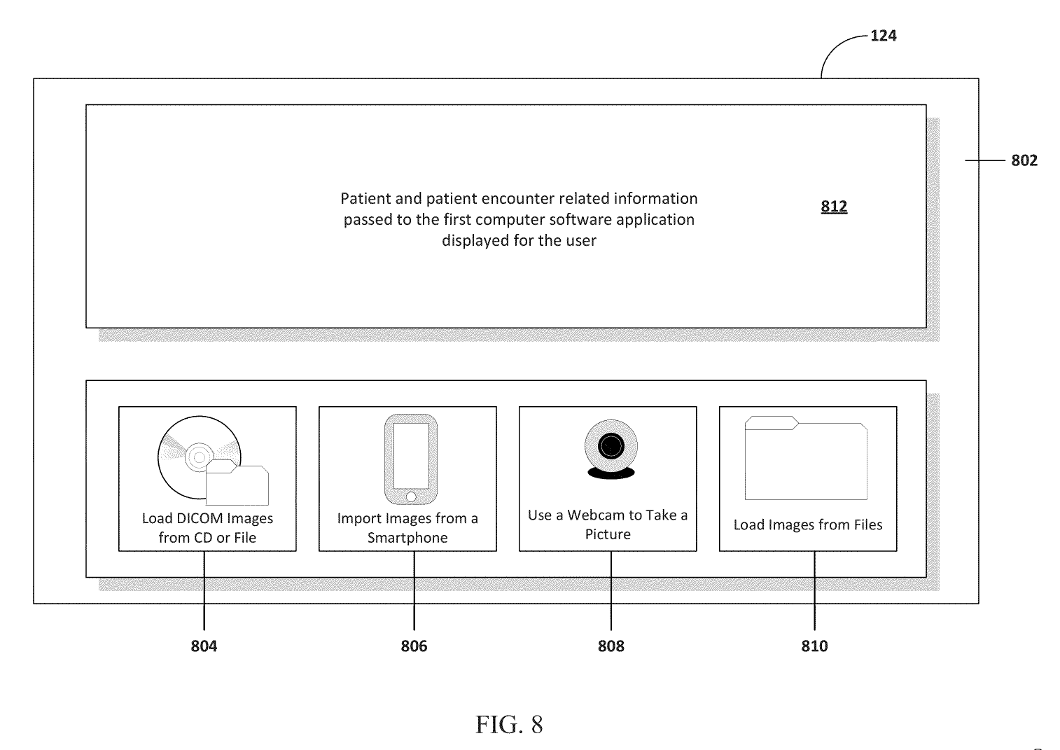

At 208, the multiple functionalities can be provided. For example, the first client computer system 104 can execute the instructions received from the second server computer system 102 to display a user interface that includes the multiple functionalities. FIG. 8 illustrates an example of a user interface 802 including functionalities to provide medical imaging data. In some implementations, the first client computer system 104 can provide the multiple functionalities as selectable objects, each representing a respective functionality. For example, the first selectable object 804 can represent a functionality to provide medical imaging data in DICOM or other format (e.g., PDF, XML, HL7, or other format) stored in physical media (e.g., CD, DVD, hard disk, other physical media, or network accessible location). The second selectable object 806 can represent a functionality to import medical imaging data from another computer system. The third selectable object 808 can represent a functionality to use a device, e.g., a camera, to capture medical imaging data. The fourth selectable object 810 can represent a functionality to provide medical imaging data in a non-DICOM format stored in physical media.

At 210, a selection of the functionality to provide additional patient-related information using another computer system is detected. In some implementations, a user of the first client computer system 104 can select the functionality to import medical imaging data from another computer system, e.g., the second client computer system 106 or another mobile computer system. For example, the user can select the object 806.

At 212, an identifier that identifies the computer session is received in response to detecting the selection. For example, the first client computer system 104 receives, e.g., from the second server computer system 102, an identifier that encodes an identity of the computer session in which the first client computer system 104 and the second server computer system 102 are exchanging the patient-related information. Notably, the identity of the computer session excludes any patient-specific private information. Instead, the identity of the computer session identifies only the computer session in which the patient-related information is being exchanged. At 214, the received identifier is displayed. For example, the first client computer system 104 can display the generated identifier in the user interface on the display device 124. In some implementations, the identifier is a quick response (QR) code or other identifier.

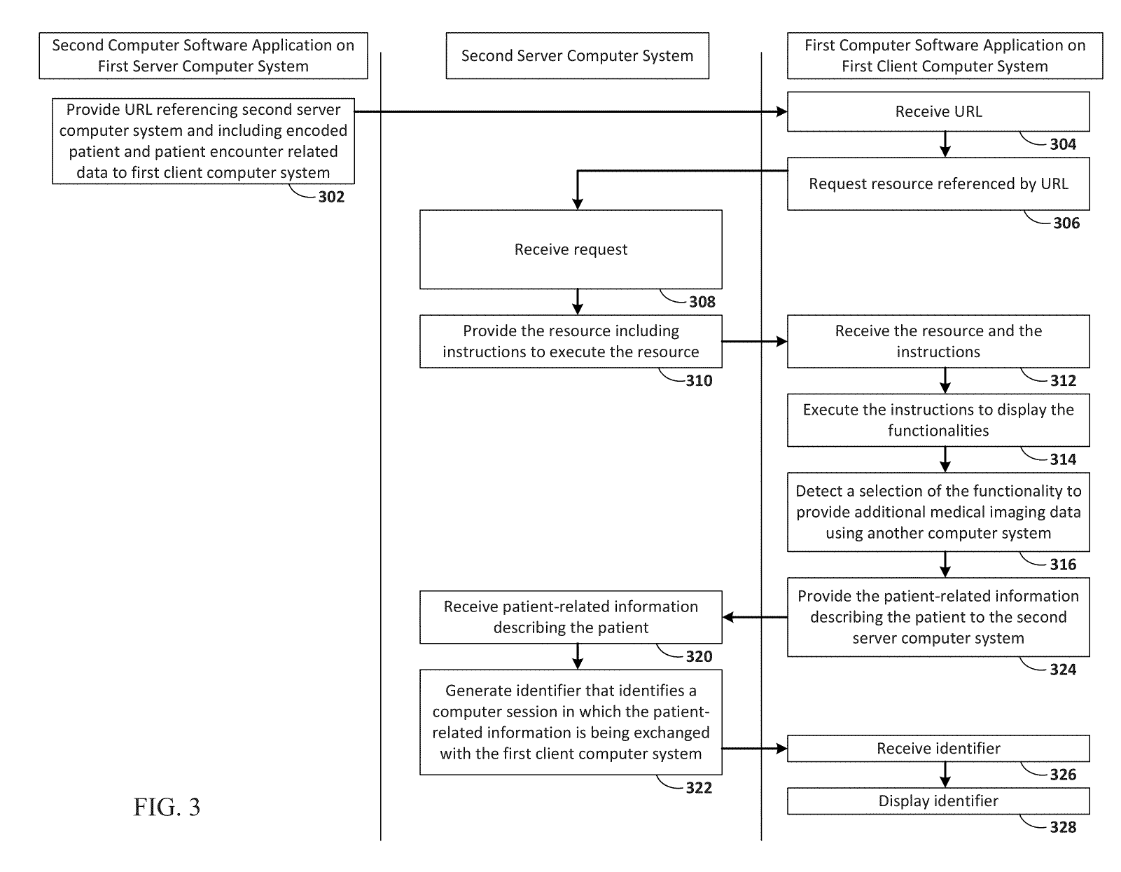

FIG. 3 describes an example workflow implemented by multiple computer systems to exchange medical imaging data by implementing portions of process 200. In the example workflow described with reference to FIG. 3, the second computer software application (E.g., EMR client software application) is executing on the first client computer system 104 and displaying patient and patient encounter-related information provided by the first server computer system 101 which can be a server that hosts patient-related information. The second server computer system can be a server that receives medical imaging data from multiple sources and routes the received medical imaging data to the first server computer system or other server computer systems. The first client computer system can be a desktop computer system using which a user exchanges patient-related information or medical imaging data (or both) with the first and second server computer systems, respectively.

At 302, the second computer software application (e.g., EMR client) on the first client computer system provides a Uniform Resource Locator (URL) referencing the second server computer system to the first client computer system. For example, the second computer software application on the first client computer system accesses the first server computer system, and displays a user interface provided by the first server computer system. The user interface includes a selectable user interface element (e.g., an icon) that a user can select to access the first computer software application. Upon detecting a selection of the user interface element, the first server computer system provides the URL referencing the second server computer system to the first client computer system. In the URL, the first server computer system encodes patient-related information which includes contextual information using which a patient can be identified.

At 304, the first client computer system receives the URL. In some implementations, the first client computer system may not parse the URL to retrieve or otherwise process the encoded patient-related information. In other words, the first client computer system may be unaware of the patient at this stage. At 306, the first client computer system requests the resource referenced by the URL. For example, the first client computer system can transmit a request for a webpage referenced by the URL. In some implementations, the first client computer system 104 can launch an external webpage and pass patient-related information, e.g., context metadata, within a query string represented by the URL format shown below:

http://hostname/?mrn=patient ID&name=last name,first name,middle
name,title,suffix&dob=date of birth&sex=sex&acc=uci encounter number&date=contact
date& time=encounter time[appointment time | time message received |instant time of
entry]&op=ua user&env=contact owner&prov=encounter provider id&mdname=encounter
provider last name,first name&mode=OP&dat=contact ID

Alternatively, or in addition, the patient-related information can be passed as one or more of a web service, an Extensible Markup Language (XML) file, a Health Level 7 (HL7) message, a Hypertext Transfer Protocol (HTTP) POST, or other by other techniques. The patient-related information allows the computer software application to identify a patient or patient encounter (or both) with which the patient-related information exchanged with the server computer system 102 is associated.

At 308, the second server computer system receives the request. At 310, the second server computer system can provide the resource including instructions to execute the resource to the first client computer system. For example, the second server computer system can transmit instructions as a Java applet or as HTML5 instructions.

At 312, the first client computer system receives the resource and the instructions. At 314, the first client computer system executes the instruction to display the functionalities described above. For example, the first client computer system can launch the Java applet to display the multiple selectable objects, each representing a functionality, in a user interface, as described above with reference to FIG. 8. At 316, the first client computer system can detect a selection of the functionality to provide additional medical imaging data using another computer system.

At 318, the first client computer system provides the patient-related information describing the patient to the second server computer system in response to detecting the selection. In some implementations, the first client computer system provides the patient-related information to the second server computer system before the additional medical imaging data is received from another computer system. In alternative implementations in which the selection is a different functionality, e.g., a functionality to provide medical imaging data in DICOM or other format (e.g., PDF, XML, HL7, or other format) stored in physical media (e.g., CD, DVD, hard disk, or other physical media, or network accessible location), the first client computer system can provide the patient-related information describing the patient to the second server computer system after the medical imaging data has been received.

At 320, the second server computer system receives the patient-related information describing the patient from the first client computer system. At 322, the second server computer system generates an identifier that identifies a computer session in which the patient-related information is being exchanged with the first client computer system. At 326, the first client computer system receives the identifier, and, at 328, displays the identifier.

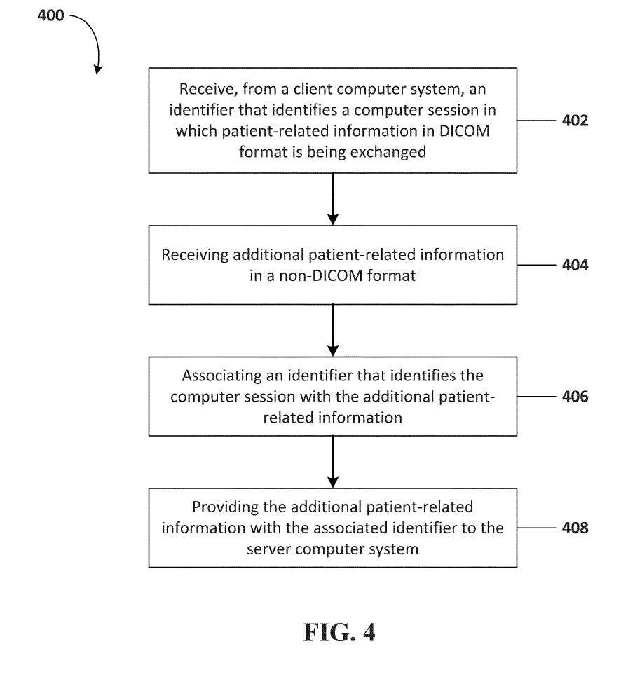

FIG. 4 is a flowchart of an example process 400 for providing medical imaging data to a computer system. In some implementations, the second client computer system 106 can implement the process 400 in conjunction with the second server computer system 102 and the first client computer system 104. For example, the second client computer system 106 can be a mobile computer system (e.g., a smartphone, a tablet computer, or other mobile computer system) that is configured to execute a computer software application to provide medical imaging data, e.g., in a non-DICOM format (e.g., visible light images), in DICOM format, or both, to the second server computer system 102. The second client computer system 106 can implement the process 300 in response to the first client computer system 104 displaying the identifier in the user interface on the display device 124 as described above with reference to FIGS. 2 and 3.

At 402, an identifier that identifies a computer session in which patient-related information describing a patient is being exchanged between a client computer system and a server computer system is received. FIG. 8 illustrates an example of a user interface 802 displayed by the first client computer system 104. The user interface 802 includes a QR code 136 identifying a computer session displayed in the display device 124. The second client computer system 106 can include a scanner to scan the identifier (e.g., the QR code 136) generated and displayed in the display device 124. Alternatively, or in addition, the second client computer system 106 can execute a scanning computer software application that can receive the identifier, e.g., by scanning A user of the second client computer system 106 can receive the identifier displayed on the display device 124. As described above, an identity of the computer session in which the first client computer system 104 and the second server computer system 102 are exchanging the patient-related information is encoded in the identifier.

At 404, additional patient-related information describing the patient is received. For example, the second client computer system 106 can include a camera using which the user can capture medical imaging data in a non-DICOM format such as visible light images, e.g., images of skin lesions or other medical images. The images can be, e.g., in at least one of a JPEG, PNG, GIF, MPG, MP4, MOV or other image file or video file format.

At 406, the identifier that identifies the computer session can be associated with the additional patient-related information. For example, the second client computer 106 can pass the images in the non-DICOM format with the identifier that identifies the computer session. At 408, the additional patient-related information with the associated identifier is provided to the second server computer system. For example, the user of the second client computer system 106 can select the “Done” icon 804 displayed in the user interface 802. In response to the input (i.e., the selection of the “Done” icon 804), the second client computer system 106 can transmit the images in the non-DICOM format with the identifier that identifies the computer session to the second server computer system 102 over the wired or wireless networks 122. Notably, the second client computer system 106 is unaware of any private information associated with the patient. Rather, the second client computer system 106 is aware of the computer session in which the first client computer system 104 and the second server computer system 102 are exchanging the patient-related information.

In some implementations, the computer software application to provide medical imaging data to the second server computer system 102 may not be installed on the second client computer system 106. In such implementations, the first client computer system 104 can display a notification 806 indicating that scanning the QR code 136 can enable installing the computer software application to provide the medical imaging data to the server computer system 102.

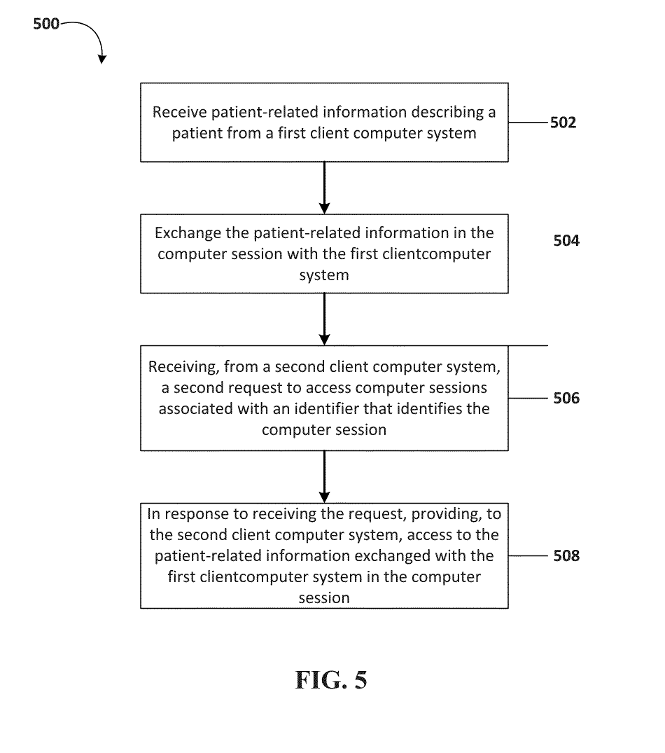

FIG. 5 is a flowchart of an example process 500 for receiving medical imaging data from multiple computer systems in the same computer session. In some implementations, the second server computer system 102 can implement the process 500 in conjunction with the first client computer system 104 and the second client computer system 106.

At 502, patient-related information describing a patient is received from a first client computer system in a computer session. For example, in response to a selection of the “Execute” button 134 displayed in the display device 124 of the first client computer system 104, the first client computer system 104 can provide patient-related information describing a patient (e.g., patient's personal information, patient encounter information, patient's provider information, and the like) to the second server computer system 102. The second server computer system 102 (or the first client computer system 104) can associate an identifier that identifies the computer session. At 504, the patient-related information is exchanged in the computer session. For example, the server computer system 102 and the first client computer system 104 can exchange the patient-related information in the computer session through the user interface described with reference to FIG. 8.

As described above, the second server computer system 102 can generate and the first client computer system 104 can display an identifier (e.g., a QR code) that identifies the computer session in a user interface displayed on the display device 124. The second client computer system 106 can receive the identifier (e.g., by scanning the QR code) and also receive medical imaging data, e.g., in a non-DICOM format or visible light images format (e.g., captured using the second client computer system 106). The second client computer system 106 can transmit additional patient-related information including the received medical imaging data associated with the identifier to the second server computer system 102. The second server computer system 102 can implement one or more or all of the following operations to include the additional patient-related information with the patient-information. Notably, the second client computer system 106 is unaware of the patient with whom the additional patient-related information is associated. Rather, the second client computer system 106 is aware of the computer session in which the second server computer system 102 and the first client computer system 104 are exchanging patient-related information.

At 506, a second request to access computer sessions associated with the identifier is received. For example, the second server computer system 102 receives, from the second client computer system 106, the identifier that identifies the computer session in which the second server computer system 102 and the first client computer system 104 are exchanging patient-related information. In response to receiving the identifier, the second server computer system 102 can search ongoing computer sessions for a computer session having the identifier that matches the received identifier.

At 508, access to the patient-related information exchanged in the identifier computer session is provided in response to receiving the second request. For example, in response to identifying the computer session having the identifier that matches the received identifier, the second server computer system 102 can associate the additional patient-related information received from the second client computer system 106 with the patient-related information being exchanged in the identified computer session. Alternatively, or in addition, the second server computer system 102 can grant the second client computer system 106 access to the patient-related information.

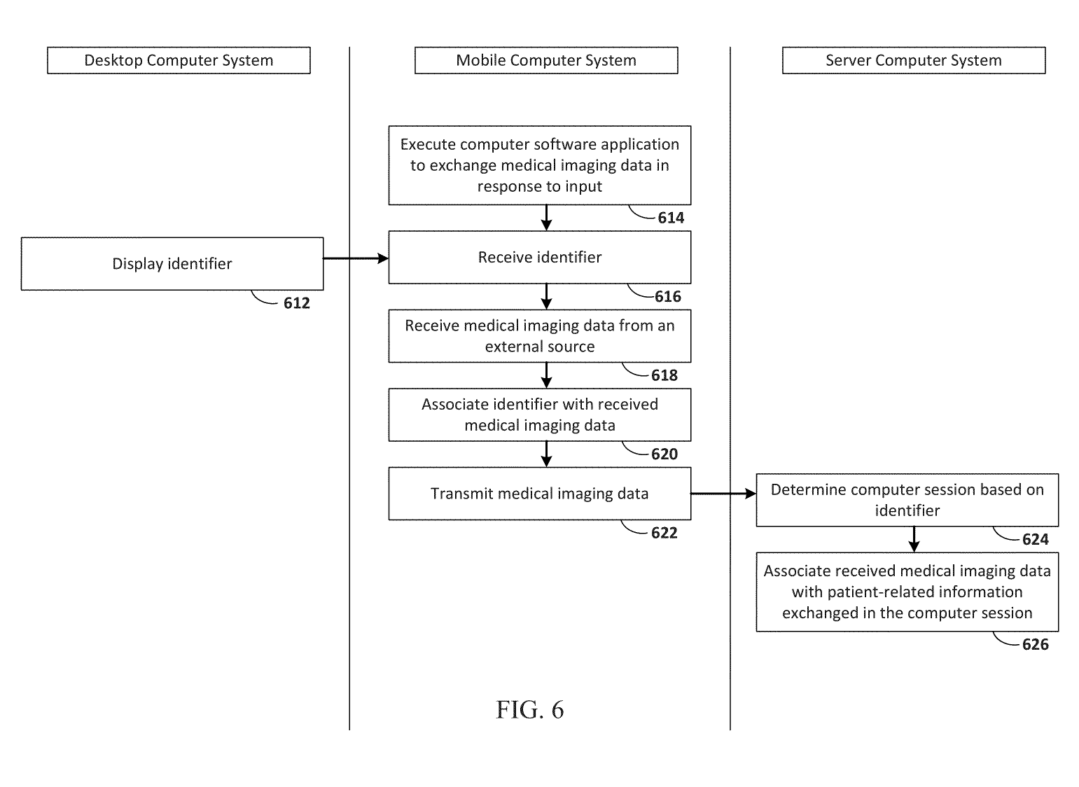

FIG. 6 describes an example workflow implemented by multiple computer systems to exchange medical imaging data by implementing all or portions of the processes 200, 400 and 500 described above. In the example workflow described in FIG. 6, the first client computer system 104 and the second client computer system 106 is a desktop computer system and a mobile computer system, respectively. Alternatively, the first client computer system 104 and the second client computer system 106 can be any computer system. The example workflow describes a scenario in which the example workflow described in FIG. 3 has been implemented resulting in the first client computer system displaying an identifier that identifies a computer session in which the first client computer system and the second server computer system are exchanging patient-related information including medical imaging data.

At 612, the desktop computer system displays the identifier, e.g., as shown in FIG. 8 and as described above with reference to FIG. 3.

At 614, the mobile computer system executes a computer software application to exchange medical imaging data in response to input. At 616, the mobile computer system receives the identifier displayed by the desktop computer system. At 618, the mobile computer system receives the medical imaging data from an external source, e.g., a camera application executed by the mobile computer system. At 620, the mobile computer system associates the identifier that identifies the computer session with the received medical imaging data. At 622, the mobile computer system transmits the medical imaging data to the second server computer system.

At 624, the second server computer system determines the computer session based on the identifier included in the received additional patient-related information. At 626, the second server computer system associates the received medical imaging data with patient-related information exchanged in the computer session in response to identifying the computer session using the received identifier.

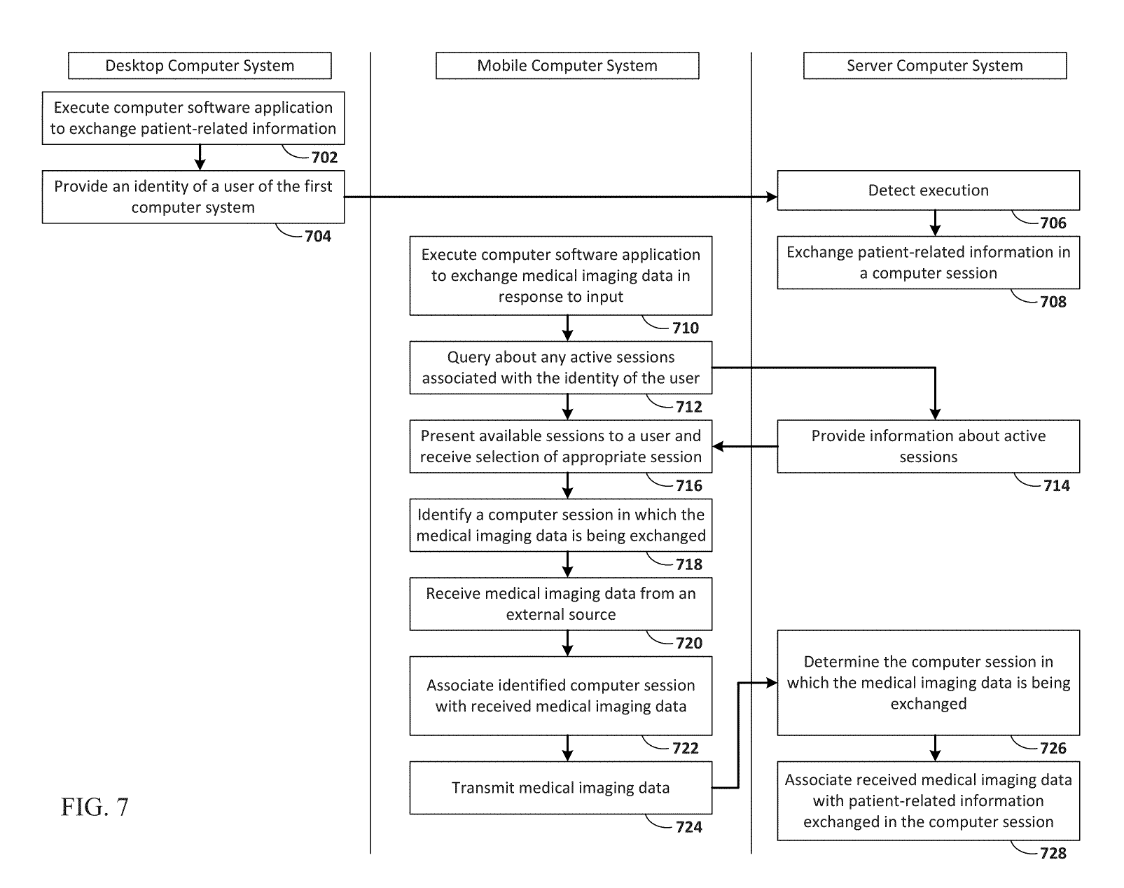

In some implementations, the second server computer system 102 can identify a user of the first client computer system 104 in response to receiving the request to exchange the patient-related information. In such implementations, the second server computer system 102 (or the first client computer system 104) can include an identity of the user in the identifier that identifies the computer session. FIG. 7 describes an example workflow implemented by multiple computer systems to exchange medical imaging data in situations in which the identity of the user of the desktop computer system is known. In such implementations, the desktop computer system need not generate and display an identifier (i.e., the QR code), as described above. Instead, exchange of the medical imaging data can occur based on the identity of the user, as described below.

At 702, the desktop computer system receives input to execute a computer software application that establishes a computer session with the second server computer system to exchange patient-related information. In response, the desktop computer system transmits a request to establish the computer session to the second server computer system. At 704, the desktop computer system provides an identity of a user of the desktop computer system to the second server computer system.

At 706, the second server computer system receives the request and detects the execution of the computer software application. At 708, the second server computer system identifies the user and exchanges patient-related information in a computer session. At 718, the second server computer system associates the identity of the user with the computer session.

At 710, the mobile computer system executes a computer software application to exchange medical imaging data in response to input. The computer software application has been configured to receive an identity of a user. In this example, the identity of the user of the mobile computer system is the same as that of the user of the desktop computer system. At 712, the mobile computer system queries the server computer system about any active sessions associated with the identity of the user, which is the same as the identity of the user of the desktop computer system. For example, the mobile computer system passes a user identifier that represents the identity of the user of the mobile computer system to the server computer system. At 714, the server computer system provides information about any active sessions associated with the identity of the user. At 716, the mobile computer system displays the available sessions, e.g., in a display screen of the mobile computer system. A user of the mobile computer system selects an appropriate session, e.g., the session in which the user is exchanging medical imaging data between the desktop computer system and the server computer system. At 718, the mobile computer system identifies a computer session in which the desktop computer system and the server computer system are exchanging the medical imaging data in response to the user's selection of the appropriate session. At 720, the mobile computer system receives medical imaging data (e.g., images in a non-DICOM format) from an external source (e.g., a camera or other source). At 722, the mobile computer system associates the computer session identifier identified at 718 with the received medical imaging data. At 724, the mobile computer system transmits the medical imaging data to the server computer system. The transmitted data includes the identity of the user.

At 726, the server computer system determines that the computer session in which the desktop computer system and the server computer system are exchanging medical imaging data. At 728, the server computer system associates the received medical imaging data with the patient-related information exchanged in the computer session.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, e.g., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., a central processing unit (CPU), a FPGA (field programmable gate array), or an ASIC (application specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example Linux, UNIX, Windows, Mac OS, Android, iOS or any other suitable conventional operating system.

A computer program, which may also be referred to or described as a program, software, a software application, an app, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a central processing unit (CPU), a FPGA (field programmable gate array), or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media (transitory or non-transitory, as appropriate) suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), or plasma monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN), a wide area network (WAN), e.g., the Internet, and a wireless local area network (WLAN).

The computing system can include clients and servers. A client and server are generally remote from each other and typically interact through a communication network. The relationship of client and server arises by virtue of computer programs running on the respective computers and having a client-server relationship to each other.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method comprising:
receiving, at a first computer system, input to execute a first computer software application to exchange medical imaging data with a first server computer system in a computer session, wherein the first computer system executes a second computer software application to exchange patient-related information describing a patient;
in response to receiving the input:
launching, at the first computer system, the first computer software application, and
receiving, at the first computer system and from the first server computer system, instructions to provide a plurality of functionalities, each functionality executable to provide additional patient-related information describing the patient to the first server computer system;
providing, at the first computer system, the plurality of functionalities including a functionality to provide the additional patient-related information using a second computer system;
detecting, at the first computer system, a selection of the functionality to provide the additional patient-related information using the second computer system; and
in response to detecting the selection:
receiving, at the first computer system and from the first server computer system, an identifier that identifies the computer session in which the patient-related information describing the patient is being exchanged between the first computer system and the first server computer system, and
displaying, at the first computer system, the identifier.

2. The method of claim 1, wherein the first computer system is a first client computer system and the second computer system is a second client computer system, and wherein providing, at the first client computer system, the plurality of functionalities comprises displaying, in a display device connected to the first client computer system, a plurality of selectable objects, each object representing a functionality of the plurality of functionalities, and wherein detecting the selection of the functionality to provide the additional patient-related information using the second client computer system comprises detecting a selection of a selectable object of the plurality of objects that corresponds to the functionality to provide the additional patient-related information using the second client computer system.

3. The method of claim 1, wherein the medical imaging data includes data objects encoded in Digital Imaging and Communication in Medicine (DICOM) format, and wherein the additional patient-related information includes medical imaging data in a non-DICOM format.

4. The method of claim 3, wherein the additional patient-related information includes medical imaging data in at least one of a JPEG, GIF, PNG, MPG, MP4, or MOV format.

5. The method of claim 1, further comprising:
displaying, at the first computer system, a user interface associated with the second computer software application;
displaying, in the user interface, a selectable user interface element associated with the first computer software application;
detecting a selection of the selectable user interface element; and
in response to detecting the selection of the selectable user interface element, causing the patient-related information to be sent from the second computer software application to the first computer software application.

6. The method of claim 1, wherein the identifier that identifies the computer session in which the patient-related information describing the patient is being exchanged between the first computer system and the server computer system includes a quick response (QR) code that includes a computer session identifier.

7. The method of claim 1, further comprising:
receiving, at the second computer system, the identifier displayed at the first computer system;
receiving, at the second computer system, the additional patient-related information; and
transmitting, by the second computer system to the first server computer system, the received additional patient-related information and the identifier that identifies the computer session in which the patient-related information describing the patient is being exchanged between the first computer system and the first server computer system.

8. The method of claim 7, further comprising:
receiving, by the first server computer system, the additional patient-related information from the second computer system and the identifier; and
associating, by the first server computer system, the additional patient-related information with the patient described by the patient-related information that is being exchanged in the computer session identified by the identifier.

9. A system comprising:
one or more processors; and
a computer-readable medium storing instructions executable by the one or more processors to perform operations comprising:
receiving, from a first computer system and in a computer session, patient-related information describing a patient, and an identifier identifying a user of the first computer system;
in response to receiving the patient-related information and the identifier identifying the user:
generating a computer session identifier identifying the computer session in which the patient-related information is received from the first computer system;
exchanging, with the first computer system, the patient-related information in the computer session;
receiving, from a second computer system, a second request to access computer sessions associated with the identifier that identifies the user of the first computer system;
in response to receiving the second request, providing, to the second computer system, access to the computer session in which the patient-related information is received from the first computer system; and
receiving, from the second computer system and in the computer session to which the second computer system has received access, additional patient-related information.

10. The system of claim 9, wherein receiving, from the second computer system, the second request to access the computer sessions associated with the identifier comprises receiving, from the second computer system, an encoded version of the identifier that identifies the user of the first computer system.

11. The system of claim 9, wherein exchanging, with the first computer system, the patient-related information in the computer session comprises receiving, from the first computer system, medical imaging data associated with the patient, the medical imaging data including data objects encoded in Digital Imaging and Communication in Medicine (DICOM) format.

12. The system of claim 9, wherein the additional patient-related information includes medical imaging data in a non-DICOM format.

13. The system of claim 12, wherein the additional patient-related information includes medical imaging data in at least one of a JPEG, GIF, PNG, MPG, MP4, or MOV format.

14. The system of claim 9, wherein, in response to receiving the second request, providing, to the second computer system, access to the patient-related information exchanged with the first computer system in the computer session in which the patient-related information is received from the first computer system comprises:
providing, to the second computer system, a plurality of computer session identifiers, each computer session identifier identifying a respective computer session associated with the identifier identifying the user of the first computer system, the plurality of computer session identifiers including the generated computer session identifier; and
receiving, from the first computer system, a selection of the generated computer session identifier.

15. The system of claim 9, the operations further comprising:
receiving, from a third computer system, a third request to access computer sessions associated with the identifier that identifies the user of the first computer system;
in response to receiving the third request, providing, to the third computer system, access to the computer session in which the patient-related information is received from the first computer system; and
receiving, from the third computer system and in the computer session to which the third computer system has received access, additional patient-related information.

16. A non-transitory computer-readable medium storing instructions executable by one or more processors to perform operations comprising:
receiving, from a client computer system, an identifier that identifies a computer session in which patient-related information describing a patient is being exchanged between the client computer system and a server computer system, wherein the patient-related information includes medical imaging data associated with the patient, the medical imaging data including data objects encoded in Digital Imaging and Communication in Medicine (DICOM) format;
receiving additional patient-related information describing the patient, the additional patient-related information including medical imaging data in a non-DICOM format;
associating the identifier that identifies the computer session with the additional patient-related information; and
providing the additional patient-related information with the associated identifier to the server computer system.

17. The medium of claim 16, wherein the identifier comprises a quick response (QR) code, and wherein receiving the identifier comprises receiving a scanned image of the QR code.

18. The medium of claim 16, wherein the medical imaging data in the non-DICOM format includes images in at least one of a JPEG, PNG, GIF, MPG, MP4, or MOV format, and wherein the operations further comprise receiving the additional patient-related information comprises receiving the images by executing an image capture application.

19. The medium of claim 16, the operations further comprising:
receiving an input to execute a computer software application to exchange the patient-related information describing the patient with a server computer system; and
in response to receiving the input, executing a functionality of the computer software application to receive the identifier that identifies the computer session.

20. The medium of claim 16, wherein the additional patient-related information includes medical imaging data in a non-DICOM format including at least one of a JPEG, GIF, or PNG format.
